(19) United States
(12) Patent Application Publication
(10) Pub. No.: US 2025/0247873 A1
(43) Pub. Date: Jul. 31, 2025

(54) SLOT AGGREGATION MODIFICATION FOR WIRELESS DEVICES WITH MECHANICAL DISPLACEMENT CAPABILITY

(71) Applicant: QUALCOMM Incorporated, San Diego, CA (US)

(72) Inventors: Vasanthan RAGHAVAN, West Windsor Township, NJ (US); Jung Ho RYU, Fort Lee, NJ (US)

(21) Appl. No.: 18/425,904

(22) Filed: Jan. 29, 2024

(51) Int. Cl. H04W 72/51; H04W 72/044; H04W 72/21

(52) U.S. Cl. CPC H04W 72/51; H04W 72/044; H04W 72/21

(57) ABSTRACT

Methods, systems, and devices for wireless communications are described. A device may receive a control signal that indicates one or more parameters for slot aggregation for the device. The slot aggregation may be associated with repetition of a transmission across a plurality of consecutive slots. The device may perform a mechanical displacement operation associated with a physical displacement of one or more antenna panels of the device. The device may transmit, based on a latency capability of the device corresponding to the mechanical displacement operation, a slot aggregation modification signal. The slot aggregation modification signal may request modification of the one or more parameters for the slot aggregation. The latency capability may be associated with a latency greater than a threshold latency.

### INTRODUCTION

The following relates generally to wireless communications, and more specifically to modifying slot aggregation configurations.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support slot aggregation modification for wireless devices with mechanical displacement capability. According to these techniques, a device may receive a control signal that indicates one or more parameters for slot aggregation for the device. The slot aggregation may be associated with repetition of a transmission across a plurality of consecutive slots. The device may perform a mechanical displacement operation associated with a physical displacement (e.g., linear displacement or rotation operations) or reflection of signals generated by one or more antenna panels of the device. The device may transmit, based on a latency capability of the device corresponding to the mechanical displacement operation, a slot aggregation modification signal. The slot aggregation modification signal may request modification of the one or more parameters for the slot aggregation. The latency capability may indicate that the device supports communications in accordance with a latency greater than a threshold latency based on the mechanical displacement operation.

A method for wireless communications by a device is described. The method may include receiving a control signal that indicates one or more parameters for slot aggregation for the device, the slot aggregation associated with repetition of a transmission across a set of multiple consecutive slots, performing a mechanical displacement operation associated with a physical displacement of one or more antenna panels of the device, and transmitting, based on a latency capability of the device corresponding to the mechanical displacement operation, a slot aggregation modification signal that requests modification of the one or more parameters for the slot aggregation, the latency capability associated with a latency greater than a threshold latency.

An apparatus for wireless communications at a device is described. The apparatus may include one or more memories and one or more processors coupled with the one or more memories and configured to cause the device to receive a control signal that indicates one or more parameters for slot aggregation for the device, the slot aggregation associated with repetition of a transmission across a set of multiple consecutive slots, perform a mechanical displacement operation associated with a physical displacement of one or more antenna panels of the device, and transmit, based on a latency capability of the device corresponding to the mechanical displacement operation, a slot aggregation modification signal that requests modification of the one or more parameters for the slot aggregation, the latency capability associated with a latency greater than a threshold latency.

Another device for wireless communications is described. The device may include means for receiving a control signal that indicates one or more parameters for slot aggregation for the device, the slot aggregation associated with repetition of a transmission across a set of multiple consecutive slots, means for performing a mechanical displacement operation associated with a physical displacement of one or more antenna panels of the device, and means for transmitting, based on a latency capability of the device corresponding to the mechanical displacement operation, a slot aggregation modification signal that requests modification of the one or more parameters for the slot aggregation, the latency capability associated with a latency greater than a threshold latency.

A non-transitory computer-readable medium storing code for wireless communications is described. The code may include instructions executable by one or more processors to receive a control signal that indicates one or more parameters for slot aggregation for the device, the slot aggregation associated with repetition of a transmission across a set of multiple consecutive slots, perform a mechanical displacement operation associated with a physical displacement of one or more antenna panels of the device, and transmit, based on a latency capability of the device corresponding to the mechanical displacement operation, a slot aggregation modification signal that requests modification of the one or more parameters for the slot aggregation, the latency capability associated with a latency greater than a threshold latency.

Some examples of the method, devices, and non-transitory computer-readable medium described herein may further include operations, features, means, or instructions for transmitting, via the slot aggregation modification signal, a request to cancel the slot aggregation for at least a time period based on the mechanical displacement operation being performed within the time period.

Some examples of the method, devices, and non-transitory computer-readable medium described herein may further include operations, features, means, or instructions for receiving, based on the request to cancel the slot aggregation, a second control signal that indicates a slot aggregation factor for the device, where the slot aggregation factor may be associated with a pause in the slot aggregation.

Some examples of the method, devices, and non-transitory computer-readable medium described herein may further include operations, features, means, or instructions for transmitting, at a first time via the slot aggregation modification signal, an indication of the time period associated with performance of the mechanical displacement operation, where the first time may be at the same time as or before a beginning of the time period.

Some examples of the method, devices, and non-transitory computer-readable medium described herein may further include operations, features, means, or instructions for transmitting a slot aggregation factor that indicates the time period.

Some examples of the method, devices, and non-transitory computer-readable medium described herein may further include operations, features, means, or instructions for rotating, displacing, or reflecting signals associated with the one or more antenna panels of the device.

Some examples of the method, devices, and non-transitory computer-readable medium described herein may further include operations, features, means, or instructions for transmitting, via the slot aggregation modification signal, an indication of a change in one or more communication parameters associated with the device, the change in the one or more communication parameters based on the mechanical displacement operation.

Some examples of the method, devices, and non-transitory computer-readable medium described herein may further include operations, features, means, or instructions for detecting an error associated with the mechanical displacement operation at the device, the change in the one or more communication parameters based on the error.

In some examples of the method, devices, and non-transitory computer-readable medium described herein, the one or more communication parameters including a gain associated with the device.

In some examples of the method, devices, and non-transitory computer-readable medium described herein, the device including a set of multiple antenna panels.

A method for wireless communications by a network entity is described. The method may include outputting a control signal that indicates one or more parameters for slot aggregation for a device, the slot aggregation associated with repetition of a transmission across a set of multiple consecutive slots, obtaining, from the device based on a latency capability of the device corresponding to a mechanical displacement operation of the device, a slot aggregation modification signal that requests modification of the one or more parameters for the slot aggregation, the latency capability associated with a latency greater than a threshold latency, and outputting, based on the slot aggregation modification signal, one or more modified parameters for the slot aggregation.

An apparatus for wireless communication at a network entity for is described. The apparatus may include one or more memories and one or more processors coupled with the one or more memories and configured to cause the network entity to output a control signal that indicates one or more parameters for slot aggregation for a device, the slot aggregation associated with repetition of a transmission across a set of multiple consecutive slots, obtain, from the device based on a latency capability of the device corresponding to a mechanical displacement operation of the device, a slot aggregation modification signal that requests modification of the one or more parameters for the slot aggregation, the latency capability associated with a latency greater than a threshold latency, and output, based on the slot aggregation modification signal, one or more modified parameters for the slot aggregation.

Another network entity for wireless communications is described. The network entity may include means for outputting a control signal that indicates one or more parameters for slot aggregation for a device, the slot aggregation associated with repetition of a transmission across a set of multiple consecutive slots, means for obtaining, from the device based on a latency capability of the device corresponding to a mechanical displacement operation of the device, a slot aggregation modification signal that requests modification of the one or more parameters for the slot aggregation, the latency capability associated with a latency greater than a threshold latency, and means for outputting, based on the slot aggregation modification signal, one or more modified parameters for the slot aggregation.

A non-transitory computer-readable medium storing code for wireless communications is described. The code may include instructions executable by one or more processors to output a control signal that indicates one or more parameters for slot aggregation for a device, the slot aggregation associated with repetition of a transmission across a set of multiple consecutive slots, obtain, from the device based on a latency capability of the device corresponding to a mechanical displacement operation of the device, a slot aggregation modification signal that requests modification of the one or more parameters for the slot aggregation, the latency capability associated with a latency greater than a threshold latency, and output, based on the slot aggregation modification signal, one or more modified parameters for the slot aggregation.

Some examples of the method, network entities, and non-transitory computer-readable medium described herein may further include operations, features, means, or instructions for obtaining, via the slot aggregation modification signal, a request to cancel the slot aggregation for at least a time period based on the mechanical displacement operation being performed by the device within the time period.

Some examples of the method, network entities, and non-transitory computer-readable medium described herein may further include operations, features, means, or instructions for outputting, based on the request to cancel the slot aggregation, a second control signal that indicates a slot aggregation factor for the device, where the slot aggregation factor may be associated with a pause in the slot aggregation.

Some examples of the method, network entities, and non-transitory computer-readable medium described herein may further include operations, features, means, or instructions for obtaining, at a first time via the slot aggregation modification signal, an indication of the time period associated with performance of the mechanical displacement operation, where the first time may be at the same time as or before a beginning of the time period.

Some examples of the method, network entities, and non-transitory computer-readable medium described herein may further include operations, features, means, or instructions for obtaining a slot aggregation factor that indicates the time period.

Some examples of the method, network entities, and non-transitory computer-readable medium described herein may further include operations, features, means, or instructions for obtaining, via the slot aggregation modification signal, an indication of a change in one or more communication parameters associated with the device, the change in the one or more communication parameters based on the mechanical displacement operation of the device.

In some examples of the method, network entities, and non-transitory computer-readable medium described herein, the one or more communication parameters including a gain associated with the device.

### BRIEF DESCRIPTION OF THE DRAWINGS

FIG. 1 shows an example of a wireless communications system that supports slot aggregation modification for wireless devices with mechanical displacement capability in accordance with one or more aspects of the present disclosure.

FIG. 2 shows an example of a network architecture that supports slot aggregation modification for wireless devices with mechanical displacement capability in accordance with one or more aspects of the present disclosure.

FIG. 3 shows an example of a wireless communications system that supports slot aggregation modification for wireless devices with mechanical displacement capability in accordance with one or more aspects of the present disclosure.

FIG. 4 shows an example of a process flow that supports slot aggregation modification for wireless devices with mechanical displacement capability in accordance with one or more aspects of the present disclosure.

FIGS. 5 and 6 show block diagrams of devices that support slot aggregation modification for wireless devices with mechanical displacement capability in accordance with one or more aspects of the present disclosure.

FIG. 7 shows a block diagram of a communications manager that supports slot aggregation modification for wireless devices with mechanical displacement capability in accordance with one or more aspects of the present disclosure.

FIG. 8 shows a diagram of a system including a device that supports slot aggregation modification for wireless devices with mechanical displacement capability in accordance with one or more aspects of the present disclosure.

FIGS. 9 and 10 show block diagrams of devices that support slot aggregation modification for wireless devices with mechanical displacement capability in accordance with one or more aspects of the present disclosure.

FIG. 11 shows a block diagram of a communications manager that supports slot aggregation modification for wireless devices with mechanical displacement capability in accordance with one or more aspects of the present disclosure.

FIG. 12 shows a diagram of a system including a device that supports slot aggregation modification for wireless devices with mechanical displacement capability in accordance with one or more aspects of the present disclosure.

FIGS. 13 through 17 show flowcharts illustrating methods that support slot aggregation modification for wireless devices with mechanical displacement capability in accordance with one or more aspects of the present disclosure.

### DETAILED DESCRIPTION

In some wireless communications systems, a device (e.g., a customer premises equipment (CPE) or some other type of wireless device) may communicate with a network entity. To reduce cost, power consumption and associated thermal overhead, the device may include a relatively small quantity of antennas, and the device may utilize a rotator, reflector, or other mechanical component (e.g., motor) to mechanically rotate an antenna or a reflector or other component to adjust a physical direction of a signal produced by the antenna, which may improve communications with the network entity using the relatively small antenna array at the device. The mechanical displacement of the antenna or reflector may be referred to as a mechanical displacement operation and may be complete within some time period. The network entity may transmit control signaling to the device to configure slot aggregation over multiple consecutive time slots, but the latency introduced by the mechanical displacement at the device may interfere with the slot aggregation. For example, the device may be unavailable for communication during the time period associated with the mechanical displacement, and the device may not support transmission or reception across consecutive slots due to the delay.

In some examples, the device may experience a mechanical failure after a quantity of mechanical displacement operations. The mechanical failure may limit the accuracy of the rotation of the device, which may lower gain at the device and disrupt communications between the device and the network entity.

In accordance with one or more aspects of the present disclosure, the device may transmit signaling, such as a slot aggregation modification signal, to a network entity to request modification of a slot aggregation configuration based on a mechanical displacement operation at the device. In some examples, the device may be a relatively high latency device due to the device performing the mechanical displacement operation(s) (e.g., the device may support a mechanical displacement capability associated with increased latency), and the signaling may provide for improved communications by such high latency devices. The slot aggregation modification signal transmitted by the device may include a slot aggregation cancelation signal, a lower gain signal associated with a mechanical displacement capability, or both. For example, the slot aggregation modification signal may request cancelation of slot aggregation based on a latency associated with the mechanical displacement operation (e.g., based on the time period for antenna rotation by the device overlapping with the configured slot aggregation). The network entity may receive the slot aggregation cancelation signal and suspend or cancel the slot aggregation configuration accordingly. Additionally, or alternatively, the slot aggregation modification signal may indicate a lower gain at the device caused by a mechanical displacement failure. For example, the device may experience a mechanical displacement failure after a quantity of mechanical rotations of the antenna. The mechanical displacement failure may lower the gain at the device based on a displacement of the antenna. The network entity may improve communications with the device based on the indicated lower gain.

The slot aggregation modification signal may enable a device having a mechanical displacement capability to indicate an impact of such a capability on an ability of the device to perform slot aggregation. Such techniques may support efficient utilization of communication resources and improved coordination between devices, among other examples. Further, by conveying a slot aggregation modification signal, the device may support a reduced quantity of antennas, which may reduce costs and power consumption, while maintaining reliable communications with a network entity. The network entity may adjust slot aggregation parameters, among other communication parameters based on the slot aggregation modification signal, which may provide for more efficient utilization of communication resources, improved reliability and throughput of communications, and the like.

Aspects of the disclosure are initially described in the context of wireless communications systems and network architectures. Additional aspects of the disclosure are described with reference to a process flow. Aspects of the disclosure are further illustrated by and described with reference to apparatus diagrams, system diagrams, and flowcharts that relate to slot aggregation modification for wireless devices with mechanical displacement capability.

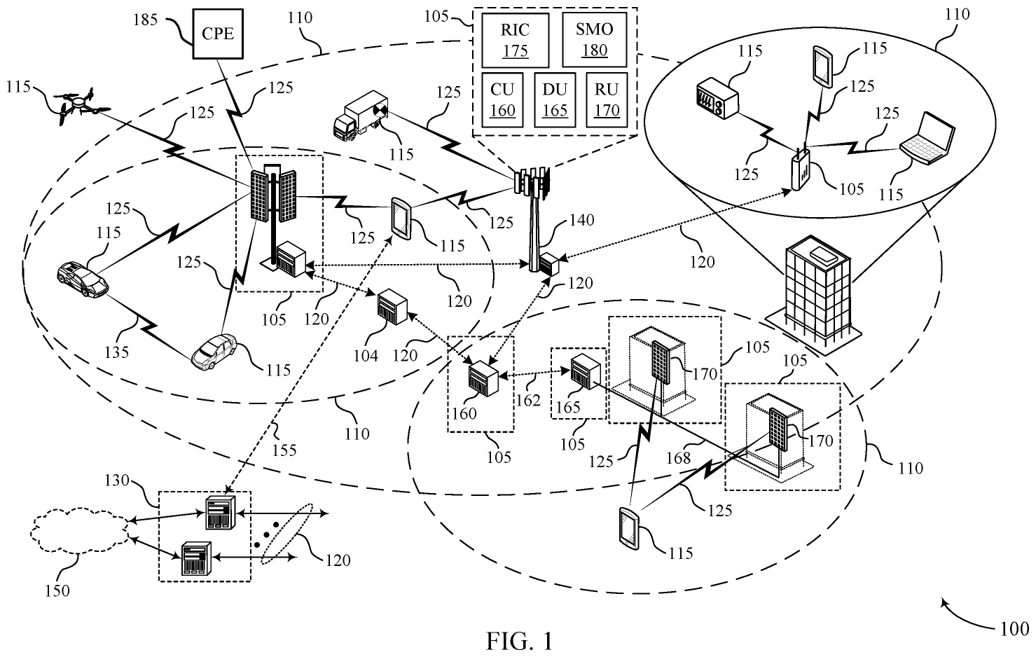

FIG. 1 shows an example of a wireless communications system 100 that supports slot aggregation modification for wireless devices with mechanical displacement capability in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (CNB), a next-generation NodeB or giga-NodeB (either of which may be referred to as a gNB), a 5G NB, a next-generation eNB (ng-cNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The electromagnetic spectrum is often subdivided, based on frequency/wavelength, into various classes, bands, channels, etc. In 5G NR two initial operating bands have been identified as frequency range designations FR1 (410 MHZ-7.125 GHZ) and FR2 (24.25 GHz-52.6 GHZ). It should be understood that although a portion of FRI is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FRI, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

Techniques described herein, in addition to or as an alternative to be carried out between UEs 115 and base stations 105, may be implemented via additional or alternative wireless devices, including IAB nodes 104, distributed units (DUs) 165, centralized units (CUs) 160, radio units (RUs) 170, and the like. For example, in some implementations, aspects described herein may be implemented in the context of a disaggregated radio access network (RAN) architecture (e.g., open RAN architecture). In a disaggregated architecture, the RAN may be split into three areas of functionality corresponding to the CU 160, the DU 165, and the RU 170. The split of functionality between the CU 160, DU 165, and RU 170 is flexible and as such gives rise to numerous permutations of different functionalities depending upon which functions (e.g., MAC functions, baseband functions, radio frequency functions, and any combinations thereof) are performed at the CU 160, DU 165, and RU 170. For example, a functional split of the protocol stack may be employed between a DU 165 and an RU 170 such that the DU 165 may support one or more layers of the protocol stack and the RU 170 may support one or more different layers of the protocol stack.

Some wireless communications systems (e.g., wireless communications system 100), infrastructure and spectral resources for NR access may additionally support wireless backhaul link capabilities in supplement to wireline backhaul connections, providing an IAB network architecture. One or more base stations 105 may include CUs 160, DUs 165, and RUs 170 and may be referred to as donor base stations 105 or IAB donors. One or more DUs 165 (e.g., and/or RUs 170) associated with a donor base station 105 may be partially controlled by CUs 160 associated with the donor base station 105. The one or more donor base stations 105 (e.g., IAB donors) may be in communication with one or more additional base stations 105 (e.g., IAB nodes 104) via supported access and backhaul links. IAB nodes 104 may support mobile terminal (MT) functionality controlled and/or scheduled by DUs 165 of a coupled IAB donor. In addition, the IAB nodes 104 may include DUs 165 that support communication links with additional entities (e.g., IAB nodes 104, UEs 115, etc.) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In some examples, the wireless communications system 100 may include a core network 130 (e.g., a next generation core network (NGC)), one or more IAB donors, IAB nodes 104, and UEs 115, where IAB nodes 104 may be partially controlled by each other and/or the IAB donor. The IAB donor and IAB nodes 104 may be examples of aspects of base stations 105. IAB donor and one or more IAB nodes 104 may be configured as (e.g., or in communication according to) some relay chain.

For instance, an access network (AN) or RAN may refer to communications between access nodes (e.g., IAB donor), IAB nodes 104, and one or more UEs 115. The IAB donor may facilitate connection between the core network 130 and the AN (e.g., via a wireline or wireless connection to the core network 130). That is, an IAB donor may refer to a RAN node with a wireline or wireless connection to core network 130. The IAB donor may include a CU 160 and at least one DU 165 (e.g., and RU 170), where the CU 160 may communicate with the core network 130 over an NG interface (e.g., some backhaul link). The CU 160 may host layer 3 (L3) (e.g., RRC, service data adaption protocol (SDAP), PDCP, etc.) functionality and signaling. The at least one DU 165 and/or RU 170 may host lower layer, such as layer 1 (L1) and layer 2 (L2) (e.g., RLC, MAC, physical (PHY), etc.) functionality and signaling, and may each be at least partially controlled by the CU 160. The DU 165 may support one or multiple different cells. IAB donor and IAB nodes 104 may communicate over an F1 interface according to some protocol that defines signaling messages (e.g., F1 AP protocol). Additionally, CU 160 may communicate with the core network over an NG interface (which may be an example of a portion of backhaul link), and may communicate with other CUs 160 (e.g., a CU 160 associated with an alternative IAB donor) over an Xn-C interface (which may be an example of a portion of a backhaul link).

IAB nodes 104 may refer to a RAN node that provides IAB functionality (e.g., access for UEs 115, wireless self-backhauling capabilities, etc.). IAB nodes 104 may include a DU 165 and an MT. A DU 165 may act as a distributed scheduling node towards child nodes associated with the IAB node 104, and the MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, an IAB node 104 may also be referred to as a parent node or a child node to other IAB nodes 104, depending on the relay chain or configuration of the AN. Therefore, the MT entity of IAB nodes 104 (e.g., MTs) may provide a Uu interface for a child node to receive signaling from a parent IAB node 104, and the DU interface (e.g., DUs 165) may provide a Uu interface for a parent node to signal to a child IAB node 104 or UE 115.

For example, IAB node 104 may be referred to a parent node associated with IAB node, and a child node associated with IAB donor. The IAB donor may include a CU 160 with a wireline (e.g., optical fiber) or wireless connection to the core network and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture (e.g., one or more IAB nodes 104 or components of IAB nodes 104) may be configured to support techniques for large round trip times in random access channel procedures as described herein. For example, some operations described as being performed by a UE 115 or a base station 105 may additionally or alternatively be performed by components of the disaggregated RAN architecture (e.g., IAB nodes, DUs, CUs, etc.).

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, a device (e.g., a CPE 185 or some other type of wireless device) may include a relatively small quantity of antennas to reduce cost, power consumption and associated thermal overhead. The device may utilize a rotator, reflector, or other component to mechanically rotate or displace an antenna or a reflector or other component to adjust a physical direction of a signal produced by the antenna, which may improve communications with the network entity 105 using the relatively small antenna array at the device. The mechanical displacement of the antenna or reflector may be referred to as a mechanical displacement operation and may be complete within some time period. The network entity 105 may transmit control signaling to the device to configure slot aggregation over multiple consecutive time slots, but the latency introduced by the mechanical displacement at the device may interfere with the slot aggregation. For example, the device may be unavailable for communication during the time period associated with the mechanical displacement, and the device may not support transmission or reception across consecutive slots due to the delay associated with the mechanical displacement.

In some examples, the device may experience a mechanical failure after a quantity of mechanical displacement operations. This may be associated with a complete or partial failure of the motor or the range of motions associated with the displacement operation. The mechanical failure may limit the accuracy of the rotation of the device, which may lower the gain achievable at the device and disrupt communications between the device and the network entity 105.

Techniques described herein provide for improved communications by such a device (e.g., CPE 185) based on signaling transmitted from the device to a network entity 105 via a communication link 125. The signaling, which may be referred to as a slot aggregation modification signal, may request modification of a slot aggregation configuration based on a mechanical displacement operation at the device. In some examples, the device may correspond to a high latency device based on the device performing the mechanical displacement operation(s), and the signaling may be supported by such high latency devices. The device may transmit the slot aggregation modification signal, which may be a slot aggregation cancelation signal, a lower gain signal, or both. For example, the slot aggregation modification signal may request cancelation of slot aggregation based on a latency associated with the antenna rotation (e.g., based on the time period for antenna rotation by the device overlapping with the configured slot aggregation). The network entity 105 may receive the slot aggregation cancelation signal and suspend or cancel the slot aggregation configuration. In some examples, the slot aggregation modification signal may indicate a lower gain at the device caused by a mechanical failure. For example, the device may experience a complete or partial mechanical failure after a quantity of mechanical rotations of the antenna. The mechanical failure may lower the gain at the device based on a displacement of the antenna. The network entity 105 may improve communications with the device based on the indicated lower gain. The slot aggregation modification signal may support efficient utilization of communication resources and improved coordination between devices, among other examples.

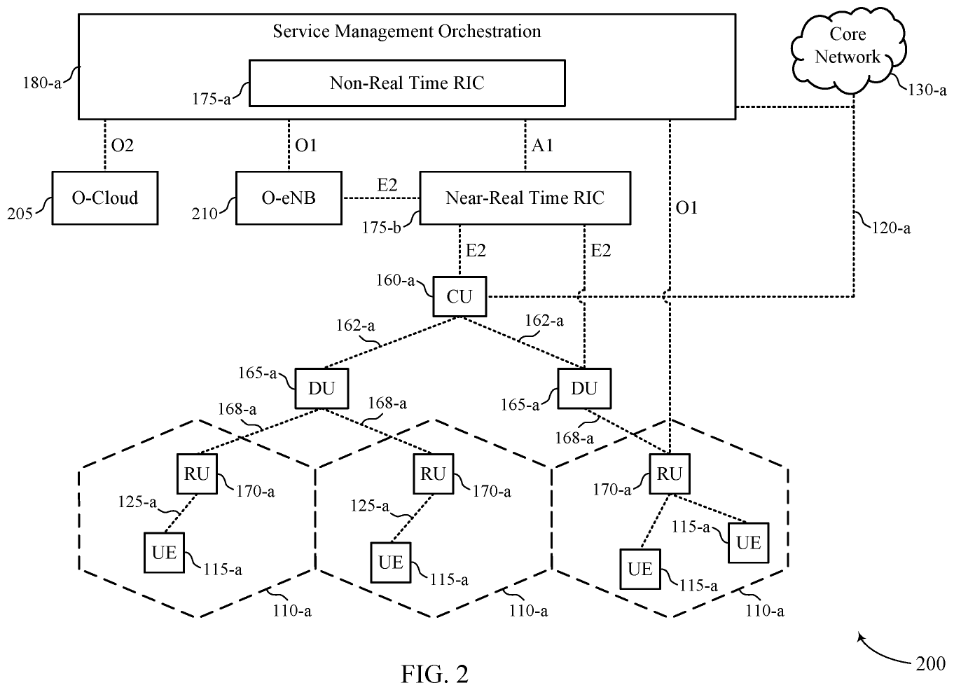

FIG. 2 shows an example of a network architecture 200 (e.g., a disaggregated base station architecture, a disaggregated RAN architecture) that supports slot aggregation modification for wireless devices with mechanical displacement capability in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an AI interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-cNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., AI policies).

In some examples, a device (e.g., a CPE 185 or some other type of wireless device) may include a relatively small quantity of antennas to reduce costs. The device may utilize a rotator, reflector, or other component to mechanically rotate an antenna or a reflector or other component to adjust a physical direction of a signal produced by the antenna, which may improve communications with one or more disaggregated network entities 105 or other nodes while using the relatively small antenna array at the device. The mechanical displacement of the antenna or reflector may be referred to as a mechanical displacement operation and may be complete within some time period. The latency introduced by the mechanical displacement at the device may interfere with any slot aggregation by the device. Additionally, or alternatively, the device may experience a mechanical failure after a quantity of mechanical displacement operations. The mechanical failure may limit the accuracy of the rotation of the device, which may lower gain at the device and disrupt communications between the device and the network.

Techniques described herein provide for a device associated with a mechanical displacement capability to transmit signaling to a network entity 105 or other node (e.g., an RU 170-a or other node) to request modification of a slot aggregation configuration based on a mechanical displacement operation at the device. In some examples, the device may correspond to a high latency device based on the device performing the mechanical displacement operation(s), and the signaling may be supported by such high latency devices. The device signaling may include slot aggregation modification signal which may be a slot aggregation cancelation signal, a lower gain signal, or both. For example, the slot aggregation modification signal may request cancelation of slot aggregation based on a latency associated with the antenna rotation (e.g., based on the time period for antenna rotation by the device overlapping with the configured slot aggregation). The network node may receive the slot aggregation cancelation signal and suspend or cancel the slot aggregation configuration. In some examples, the slot aggregation modification signal may indicate a lower gain at the device caused by a mechanical failure. For example, the device may experience a mechanical failure after a quantity of mechanical rotations of the antenna. The mechanical failure may lower the gain at the device based on a displacement of the antenna. The network may improve communications with the device based on the indicated lower gain. The slot aggregation modification signal may support efficient utilization of communication resources and improved coordination between devices.

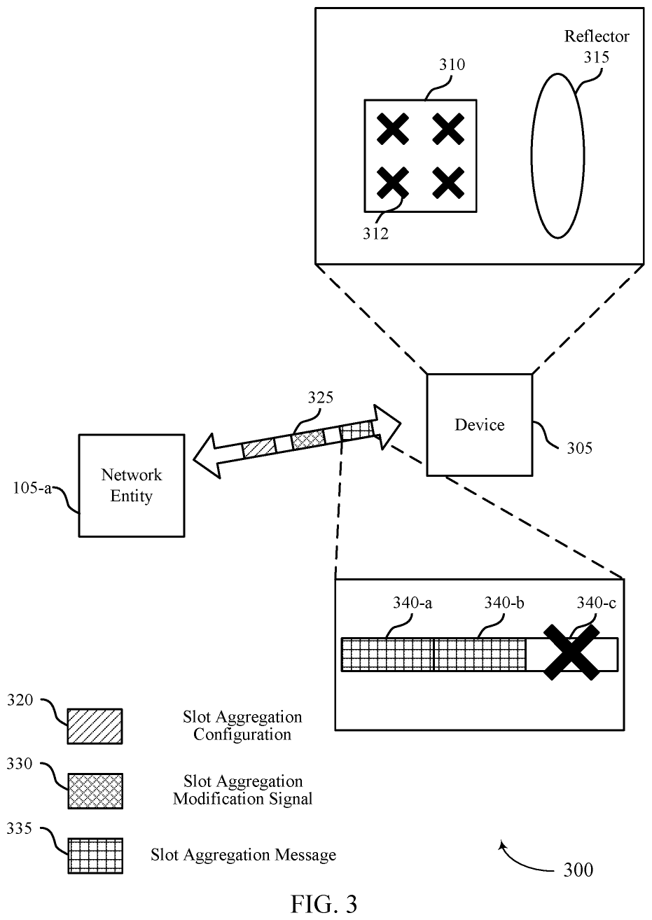

FIG. 3 shows an example of a wireless communication system 300 that supports slot aggregation modification for wireless devices with mechanical displacement capability in accordance with one or more aspects of the present disclosure. In some examples, a network entity 105-a may communicate with a device 305 via a communication link 325 (e.g., an uplink and downlink communication link, a Uu link). The device 305 may represent an example of a UE, such as the UEs 115 described with reference to FIG. 1, a CPE, such as the CPEs 185 as described with reference to FIG. 1, or some other type of wireless device. The device 305 may communicate using one or more antenna panels 310. In some examples, the device 305 may be associated with reduced costs, relatively higher latency than other devices, or both. For example, the device 305 may include a relatively small quantity of antenna elements 312 in the antenna panel 310 (e.g., a 4×4 antenna panel, or some other antenna panel size to reduce hardware costs).

The device 305 may utilize a reflector 315 to mechanically displace signals produced by the antenna panel 310 to increase array gain without increasing a size of the antenna panel 310 (e.g., without utilizing an 8×8, 16×8 or 16×16 antenna panel, among other examples). The reflector 315 may represent an example of a Cassegrain reflector, a mechanical rotator, or some other component that is operable to rotate, reflect, or otherwise move the antenna elements 312 or a signal produced by the antenna elements 312 in the antenna panel 310 to increase gain. In other words, the mechanical displacement may provide for improved equivalent isotropic radiated power (EIRP). For example, the device 305 may rotate the antenna panel 310 or the reflector 315 to modify transmitted signal directions (e.g., spatial streams, beams) generated by the antenna panel 310 and improve communications with the network entity 105-a.

In some examples, the antenna panel 310 may include one or more antenna elements. The device 305 may utilize the reflector 315 or the mechanical rotator to mechanically separate or displace the one or more antenna panels 310. In some cases, the mechanical displacement of the antenna panel 310 may include the separation or displacement of the one or more antenna panels 310 in the device 305. The device 305 may include a mechanical displacement apparatus (e.g., one or more motors) that may rotate, reflect or displace the antenna panels 310. The one or more antenna panels 310 may be collocated for communications with a single node, or non co-located for communication with multiple nodes, or both based on the mechanical displacement. One of the antenna panels 310 may rotate from a co-located position to a non-collocated location, which may enable the device 305 to communicate with multiple nodes. The antenna panel displacement may be linear (e.g., along an axis, such as the X axis, the Y axis, or both) or angular (e.g., rotation around an axis from one location to another).

The mechanical displacement of the antenna panel 310 may be complete within some time period (e.g., a few seconds or a few tens of seconds). That is, mechanically rotating, reflecting, shifting, or otherwise moving the antenna panel 310 may be associated with some mechanical displacement latency. During the mechanical displacement, the device 305 may be unable to communicate with the network entity 105-a. As such, the mechanical displacement may result in a “no operation time,” where the antenna panel 310 in the device 305 may not support communications with the network entity 105-a. Communication between the network entity 105-a and the device 305 may be associated with relatively high latency based on the mechanical displacement and corresponding no operation time.

The mechanical displacement may be referred to as a mechanical displacement operation. In some examples, the device 305 may be referred to as a mechanical displacement capable device based on the device 305 performing one or more mechanical displacement operations. The mechanical displacement operations may correspond to a latency capability. That is, because the device 305 may include the relatively small quantity of antenna elements 312 in the antenna panel 310 and support mechanical displacement of the antenna panel 310 to reduce costs, the device may support communications associated with relatively high latency. The device 305 may correspond to the latency capability based on the relatively high latency associated with the mechanical displacement of the antenna panel 310. The latency capability may be associated with a relatively high latency of communication due to dynamic pauses for mechanical displacement of the antenna panel 310.

The network entity 105-a and the device 305 may support slot aggregation. The network entity 105-a may configure the device 305 to perform slot aggregation over multiple consecutive slots. Slot aggregation may correspond to communications that use the same transport block (TB) over multiple slots while one or more beams used by the network entity 105-a remain the same over each slot. In other words, the device 305 may transmit the same message to the network entity 105-a over multiple consecutive slots, or vice versa. For example, the device 305 may transmit the same slot aggregation message 335 to the network entity 105-a via the communication link 325 during the consecutive slots 340 (e.g., slot 340-a, slot 340-b, slot 340-c), which may be consecutive in time (e.g., may include consecutive symbols allocated for the slot aggregation). The device 305 and the network entity 105-a may utilize a same beam to receive the message and different beams to transmit the message in each slot, such that the devices may obtain different measurements of the signaling over time. The device 305 and/or the network entity 105-a may receive the signaling and perform channel estimation over the multiple consecutive slots to increase gain.

However, the device 305 may be unable to perform channel estimation over the consecutive slots if the device 305 performs a mechanical displacement operation over one or more of the consecutive time slots. Additionally, or alternatively, the device 305 may be unable to perform slot aggregation using joint channel estimation across the multiple consecutive slots due to the mechanical displacement at the device 305. Joint channel estimation may lead to gains via each additional channel measurement which may be indicated by device 305 to the network entity 105-a.

The network entity 105-a may transmit slot aggregation configuration 320 via the communication link 325 indicating consecutive time slots for transmission. In some cases, the device 305 may be unavailable for transmission or reception during one or more of the consecutive time slots due to a mechanical displacement of the antenna panel 310. If the device 305 performs mechanical displacement, the device 305 may be unable to perform the slot aggregation configured by the network entity 105-a. Stated alternatively, if slot aggregation is configured by the network entity 105-a, the device 305 may be unable to perform both mechanical displacement and the configured slot aggregation.

In some examples, the mechanical displacement may be enabled by a motor at the device 305. The motor may wear down over time with repeated use. The device 305 may experience mechanical failure after some quantity of mechanical displacements of the antenna panel 310 or antenna elements 312 (e.g., a failure in the motor). The antenna panel 310 or the antenna elements 312 may be set in a non-collocated, fixed, or faulty position that may not adapt to dynamic channel conditions because of the mechanical failure. The mechanical failure may limit the accuracy of the mechanical displacement of the antenna panel 310. For example, the device 305 may attempt to rotate the antenna panel 310 or the reflector 315 to a first location. Due to the mechanical failure, the antenna panel 310 may be rotated to a second, less accurate location. The mechanical failure may cause a lower gain at the device 305 based on the location error. For example, the network entity 105-a may receive a lower gain signal from the device 305 based on the displacement between the second less accurate location and the first location. In other examples, the device 305 may be unable to rotate the antenna panel 310. Additionally, or alternatively, the device 305 may be unable to displace or separate one or more antenna panels 310 accurately due to the mechanical failure. In some cases, the location error may reduce the improved gain from slot aggregation. For example, the channel estimation performed during slot aggregation may be based on estimation across all of the consecutive time slots. Each slot may provide an increase in gain by an additional channel estimation improvement. If the one or more antenna panels 310 are not able to accurately perform a mechanical displacement back to an original position for slot aggregation due to the mechanical failure, the additional channel estimation may not provide an increase in gain creating a lower gain at the device 305.

According to techniques described herein, the device 305 may request modification of a slot aggregation configuration to improve communications while supporting mechanical displacement operations for the antenna panel 310. For example, the device 305 may transmit a slot aggregation modification signal 330 via the communication link 325. In some examples, the slot aggregation modification signal 330 may include a request to cancel slot aggregation, an indication of a change in communication parameters based on the mechanical displacement, or both. The request to cancel the slot aggregation may indicate the beginning of a mechanical displacement operation at the device 305. The device 305 may transmit the slot aggregation modification signal 330 at the same time that the device 305 begins a mechanical displacement operation or before (e.g., one slot, or some other quantity of slots before) the mechanical displacement operation begins. For example, the device 305 may be configured to transmit the slot aggregation message during consecutive slots 340-a, 340-b, and 340-c and the device 305 may begin a mechanical rotation of the antenna panel 310 or the reflector 315 during the slot 340-c. The device 305 may transmit the slot aggregation modification signal 330 including a request to cancel the slot aggregation at least one slot 340 before the mechanical displacement operation begins (e.g., during the slot 340-b). In some other examples, the device 305 may transmit the slot aggregation modification signal 330 including a request to cancel the slot aggregation at the same time that the device 305 begins the mechanical displacement operation (e.g., during the slot 340-c). The device 305 may indicate, via the slot aggregation modification signal 330 or some other signaling, the time period of the mechanical displacement at the device 305. For example, the device 305 may indicate the time period of a mechanical displacement operation at the device 305 via a slot aggregation factor. The slot aggregation factor value may correspond to a preconfigured time period. In some examples, if the slot aggregation modification signal 330 indicates a request to cancel the slot aggregation, the signal may be referred to as a slot aggregation cancelation signal.

The network entity 105-a may receive the slot aggregation modification signal 330 via the communication link 325. The network entity 105-a may cancel or suspend the slot aggregation configured for the device 305 based on the slot aggregation modification signal 330 including the request to cancel slot aggregation. For example, the slot aggregation may be canceled in the slot 340-c, as illustrated in FIG. 3. The network entity 105-a may cancel the slot aggregation based on the time period of the mechanical displacement indicated by the device 305. The network entity 105-a may indicate the cancelation of the slot aggregation via control signaling conveyed via the communication link 325, or the network entity 105-a may refrain from indicating the cancelation, and the device 305 may assume the aggregation is canceled based on transmitting the slot aggregation modification signal 330. In some cases, the network entity 105-a may set the value of the aggregation factor to a preconfigured cancelation value (e.g., set the value to zero) to indicate the cancelation of the slot aggregation.

Additionally, or alternatively, the slot aggregation modification signal 330 may include an indication of a change in communication parameters based on the mechanical displacement. The indication of the change in communication parameters may indicate that a mechanical failure has occurred at the device 305 and may indicate a lower gain due to the mechanical failure at the device 305, among other examples of parameters which may change due to the mechanical failure. The device 305 may transmit the slot aggregation modification signal 330 to the network entity 105-a after experiencing and detecting a mechanical failure. The network entity 105-a may use the indication of potentially lower gain or other changes in communication parameters indicated via the slot aggregation modification signal 330 to improve communications with the device 305. For example, the network entity 105-a may determine to perform slot aggregation, pause slot aggregation, cancel slot aggregation, or otherwise adjust one or more timing parameters associated with slot aggregation based on the indication. Additionally, or alternatively, the slot aggregation modification signal 330 may indicate a change in location of one or more antennas at the device 305, and the network entity 105-a may adjust a transmission configuration indicator (TCI) state, a quasi co-location (QCL) configuration, or both based on the change in location of the antennas.

The slot aggregation modification signal 330 may thereby indicate, to the network entity 105-a, whether a device 305 is performing a mechanical displacement operation that may interfere with slot aggregation, whether the device 305 has experienced a mechanical failure, or both, which may support efficient utilization of communication resources and improved coordination between devices, including devices that may support a mechanical displacement capability and corresponding latency requirements.

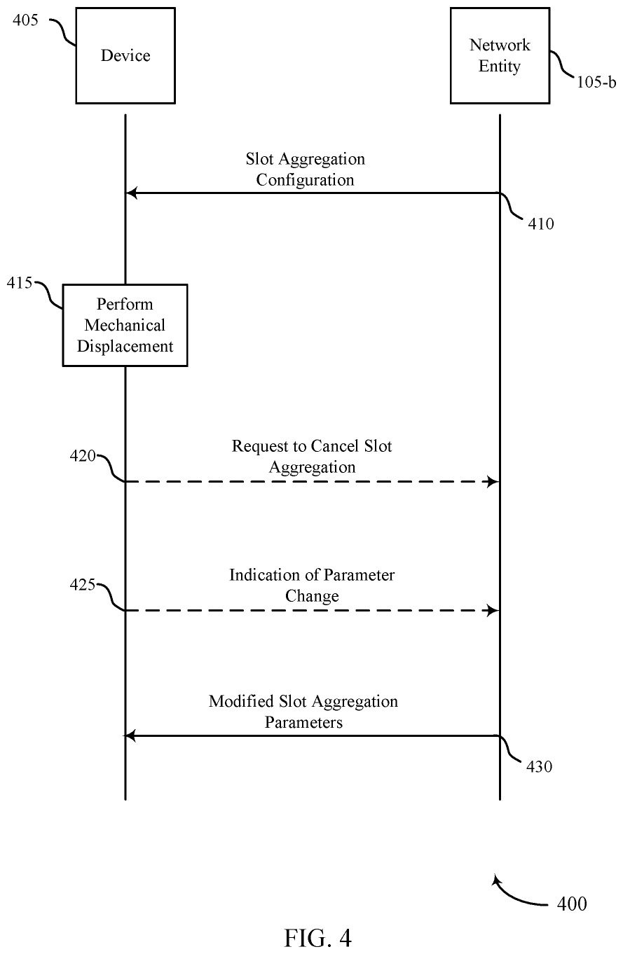

FIG. 4 shows an example of a process flow 400 that supports slot

aggregation modification for wireless devices with mechanical displacement capability in accordance with one or more aspects of the present disclosure. The process flow 400 may implement aspects of wireless communications systems 100 and 300, or may be implemented by aspects of the wireless communications system 100 and 300. For example, the process flow 400 may illustrate operations between a device 405 and a network entity 105-b, which may be examples of corresponding devices described herein. The device 405 may represent an example of a UE, such as the UEs 115 described with reference to FIG. 1, a CPE, such as the CPEs 185 as described with reference to FIG. 1, a device 305 with reference to FIG. 3, or some other type of wireless device. The device 405 may include one or more antenna panels.

In the following description of the process flow 400, the operations between the device 405 and the network entity 105-b may be performed in different orders or at different times than the example shown. Some operations may also be omitted from the process flow 400, and other operations may be added to the process flow 400. In this example, the network entity 105-b and the device 405 may exchange slot aggregation modification signaling that supports improved communications between the network entity 105-b and the device 405 regardless of a mechanical displacement and/or latency capability of the device 405.

At 410, the network entity 105-b may output a control signal that indicates one or more parameters for slot aggregation for the device 405. The slot aggregation may be associated with repetition of a transmission across multiple consecutive slots. For example, the one or more parameters for slot aggregation may schedule multiple (e.g., 2, 4, or 8) repeated transmissions of a message. The multiple repeated transmissions may be scheduled during the consecutive slots. The slot aggregation may be described in further detail elsewhere herein, including with reference to FIG. 3.

At 415, the device 405 may perform a mechanical displacement operation associated with a physical displacement of one or more antenna panels of the device 405. The mechanical operation may include rotating, displacing, or reflecting signals associated with (e.g., produced by) the one or more antenna panels of the device. For example, the device 405 may mechanically displace or separate one or more antenna panels of the device 405, or the device may adjust a reflector to modify a reflection of signals generated by the antenna panels, or the like. During the mechanical operation, the device 405 may be unable to communicate with the network entity 105-b. As such, the mechanical operation may be associated with a relatively high latency. The device 405 may be associated with a latency capability based on the relatively high latency of the mechanical operation. In some cases, the device 405 may perform the mechanical operation during the consecutive slots scheduled for slot aggregation.

The device 405 may transmit a slot aggregation modification signal based on the latency capability of the device 405 corresponding to the mechanical displacement operation. The slot aggregation modification signal may request modification of the one or more parameters for the slot aggregation. The latency capability of the device 405 may be associated with a latency greater than a threshold latency due to, for example, the device 405 performing one or more mechanical displacement operations which may delay other communications. The slot aggregation modification signal may include a request to cancel the slot aggregation, an indication of a change in one or more communication parameters, or both.

In some cases, at 420, the device 405 may transmit the slot aggregation modification signal including a request to cancel the slot aggregation for a time period (e.g., a first instance of the slot aggregation modification signal). The device 405 may transmit the request to cancel the slot aggregation based on the device 405 performing or preparing to perform a mechanical displacement operation within the time period. In some cases, the device 405 may transmit, at a first time via the slot aggregation modification signal, an indication of the time period associated with the mechanical displacement operation. The first time may be at the same time as or before a beginning of the time period. For example, the device 405 may signal the request to cancel the slot aggregation at the same time that the device 405 initiates the mechanical displacement operation or one or more slots before the device 405 initiates the mechanical displacement operation. The device 405 may transmit a slot aggregation factor that indicates the time period. For example, the device 405 may indicate the amount of time the mechanical displacement operation will use via a slot aggregation factor value.

Additionally, or alternatively, at 425, the device 405 may transmit the slot aggregation modification signal including an indication of a change in one or more communication parameters associated with the device 405. The change in the one or more communication parameters may be based on the mechanical displacement operation. The device 405 may detect an error associated with the mechanical displacement operation at the device 405. The change in the one or more communication parameters may be based on the error. The one or more communication parameters may include a gain associated with the device 405, an antenna placement, a QCL configuration of the device 405, or any combination thereof. For example, the device 405 may detect an error in the mechanical displacement operations at the device 405 (e.g., the device 405 may experience a mechanical failure reducing the accuracy of the mechanical displacement). The error in the mechanical displacement operations at the device 405 may lower the gain at the device 405. The device 405 may indicate the lower gain to the network entity 105-a.

At 430, the network entity 105-b may output one or more modified parameters for the slot aggregation based on the slot aggregation modification signal. The one or more modified parameters may include an indication of a cancelation or suspension of the slot aggregation or improved communication scheduling. In some examples, the network entity 105-b may output a second control signal that indicates a slot aggregation factor for the device 405 based on the request to cancel the slot aggregation. The slot aggregation factor may be associated with a pause in the slot aggregation. For example, the network entity 105-b may output control signaling including a predefined slot aggregation factor cancelation value (e.g., zero as a choice which could be agreed to indicate a cancelation operation). The slot aggregation factor cancelation value may indicate the cancelation of the slot aggregation. Additionally, or alternatively, the network entity 105-b may modify parameters for the slot aggregation based on the indication of a change in one or more communication parameters at the device 405. For example, the network entity 105-b may modify and output parameters for the slot aggregation based on the indication of lower gain at the device 405. Additionally, or alternatively, the network entity 105-b may improve communication with the device 405 based on the indication of lower gain at the device 405.

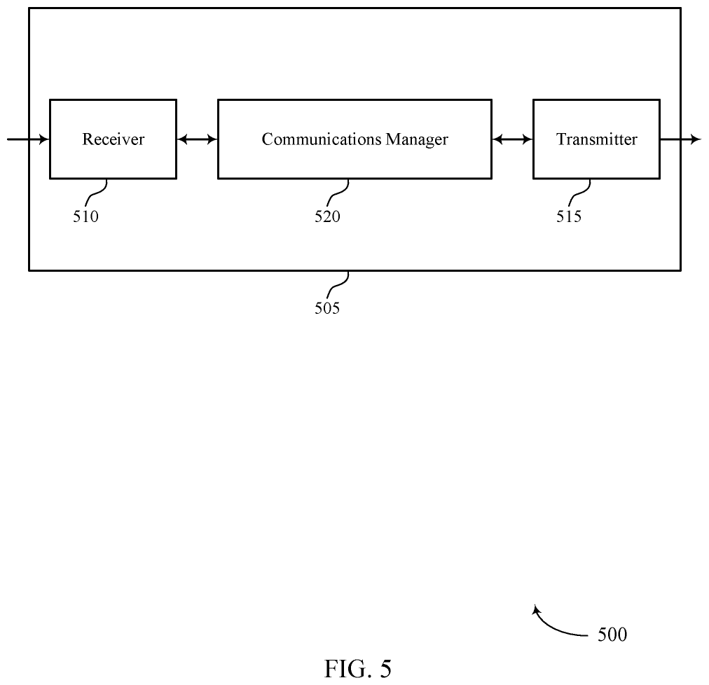

FIG. 5 shows a block diagram 500 of a device 505 that supports slot aggregation modification for wireless devices with mechanical displacement capability in accordance with one or more aspects of the present disclosure. The device 505 may be an example of aspects of a device as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to slot aggregation modification for wireless devices with mechanical displacement capability). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to slot aggregation modification for wireless devices with mechanical displacement capability). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of slot aggregation modification for wireless devices with mechanical displacement capability as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a control signal that indicates one or more parameters for slot aggregation for the device, the slot aggregation associated with repetition of a transmission across a set of multiple consecutive slots. The communications manager 520 is capable of, configured to, or operable to support a means for performing a mechanical displacement operation associated with a physical displacement of one or more antenna panels of the device. The communications manager 520 is capable of, configured to, or operable to support a means for transmitting, based on a latency capability of the device corresponding to the mechanical displacement operation, a slot aggregation modification signal that requests modification of the one or more parameters for the slot aggregation, the latency capability associated with a latency greater than a threshold latency.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced power consumption, more efficient utilization of communication, and the like.

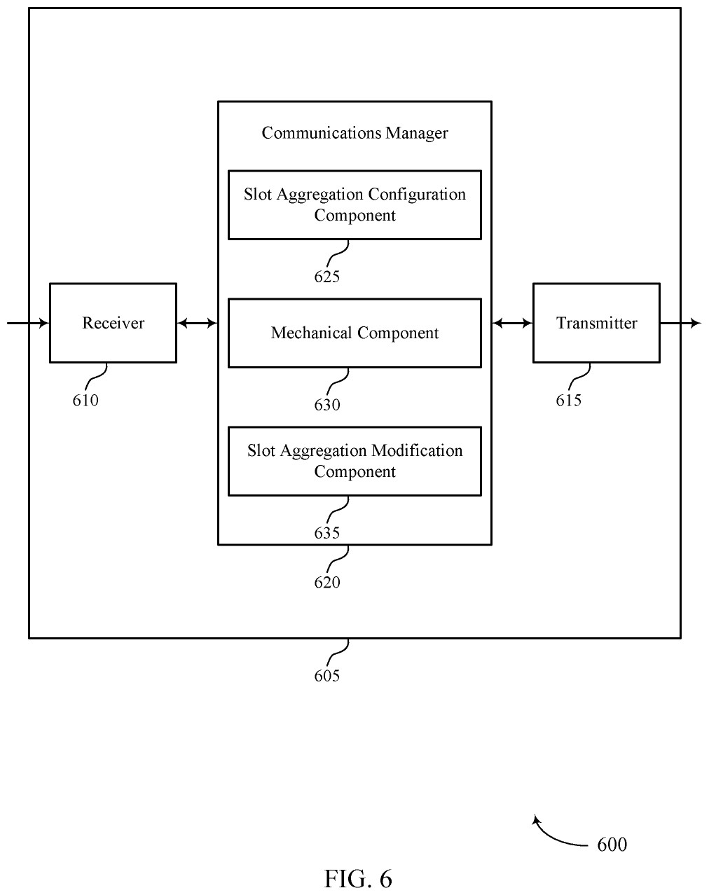

FIG. 6 shows a block diagram 600 of a device 605 that supports slot aggregation modification for wireless devices with mechanical displacement capability in accordance with one or more aspects of the present disclosure. The device 605 may be an example of aspects of a device 505 or a device 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to slot aggregation modification for wireless devices with mechanical displacement capability). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to slot aggregation modification for wireless devices with mechanical displacement capability). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of slot aggregation modification for wireless devices with mechanical displacement capability as described herein. For example, the communications manager 620 may include a slot aggregation configuration component 625, a mechanical component 630, a slot aggregation modification component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The slot aggregation configuration component 625 is capable of, configured to, or operable to support a means for receiving a control signal that indicates one or more parameters for slot aggregation for the device, the slot aggregation associated with repetition of a transmission across a set of multiple consecutive slots. The mechanical component 630 is capable of, configured to, or operable to support a means for performing a mechanical displacement operation associated with a physical displacement of one or more antenna panels of the device. The slot aggregation modification component 635 is capable of, configured to, or operable to support a means for transmitting, based on a latency capability of the device corresponding to the mechanical displacement operation, a slot aggregation modification signal that requests modification of the one or more parameters for the slot aggregation, the latency capability associated with a latency greater than a threshold latency.

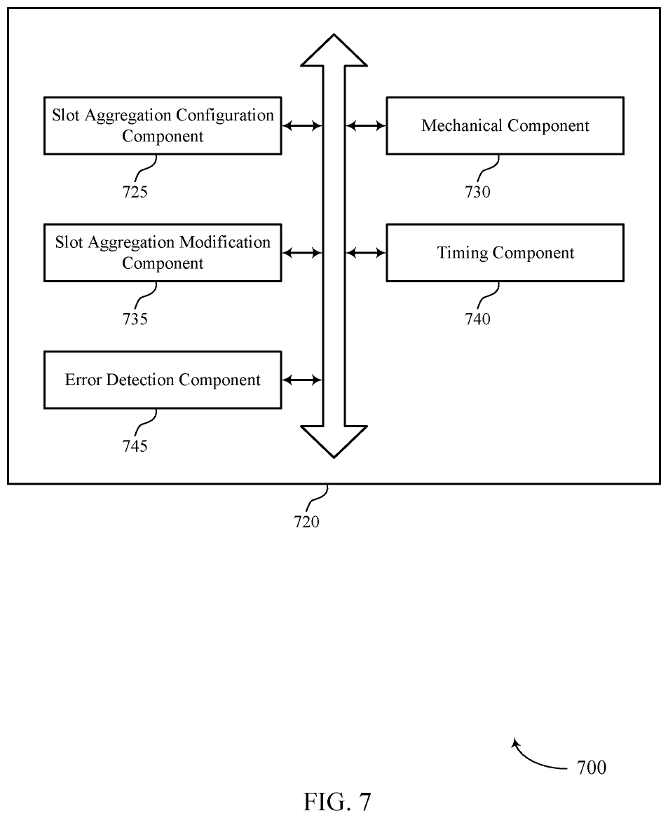

FIG. 7 shows a block diagram 700 of a communications manager 720 that

supports slot aggregation modification for wireless devices with mechanical displacement capability in accordance with one or more aspects of the present disclosure. The communications manager 720 may be an example of aspects of a communications manager 520, a communications manager 620, or both, as described herein. The communications manager 720, or various components thereof, may be an example of means for performing various aspects of slot aggregation modification for wireless devices with mechanical displacement capability as described herein. For example, the communications manager 720 may include a slot aggregation configuration component 725, a mechanical component 730, a slot aggregation modification component 735, a timing component 740, an error detection component 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The slot aggregation configuration component 725 is capable of, configured to, or operable to support a means for receiving a control signal that indicates one or more parameters for slot aggregation for the device, the slot aggregation associated with repetition of a transmission across a set of multiple consecutive slots. The mechanical component 730 is capable of, configured to, or operable to support a means for performing a mechanical displacement operation associated with a physical displacement of one or more antenna panels of the device. The slot aggregation modification component 735 is capable of, configured to, or operable to support a means for transmitting, based on a latency capability of the device corresponding to the mechanical displacement operation, a slot aggregation modification signal that requests modification of the one or more parameters for the slot aggregation, the latency capability associated with a latency greater than a threshold latency.

In some examples, the slot aggregation modification component 735 is capable of, configured to, or operable to support a means for transmitting, via the slot aggregation modification signal, a request to cancel the slot aggregation for at least a time period based on the mechanical displacement operation being performed within the time period.

In some examples, the slot aggregation configuration component 725 is capable of, configured to, or operable to support a means for receiving, based on the request to cancel the slot aggregation, a second control signal that indicates a slot aggregation factor for the device, where the slot aggregation factor is associated with a pause in the slot aggregation.

In some examples, the timing component 740 is capable of, configured to, or operable to support a means for transmitting, at a first time via the slot aggregation modification signal, an indication of the time period associated with performance of the mechanical displacement operation, where the first time is at the same time as or before a beginning of the time period.

In some examples, the timing component 740 is capable of, configured to, or operable to support a means for transmitting a slot aggregation factor that indicates the time period.

In some examples, the mechanical component 730 is capable of, configured to, or operable to support a means for rotating, displacing, or reflecting signals associated with the one or more antenna panels of the device.

In some examples, the slot aggregation modification component 735 is capable of, configured to, or operable to support a means for transmitting, via the slot aggregation modification signal, an indication of a change in one or more communication parameters associated with the device, the change in the one or more communication parameters based on the mechanical displacement operation.

In some examples, the error detection component 745 is capable of, configured to, or operable to support a means for detecting an error associated with the mechanical displacement operation at the device, the change in the one or more communication parameters based on the error.

In some examples, the one or more communication parameters including a gain associated with the device.

In some examples, the device including a set of multiple antenna panels.

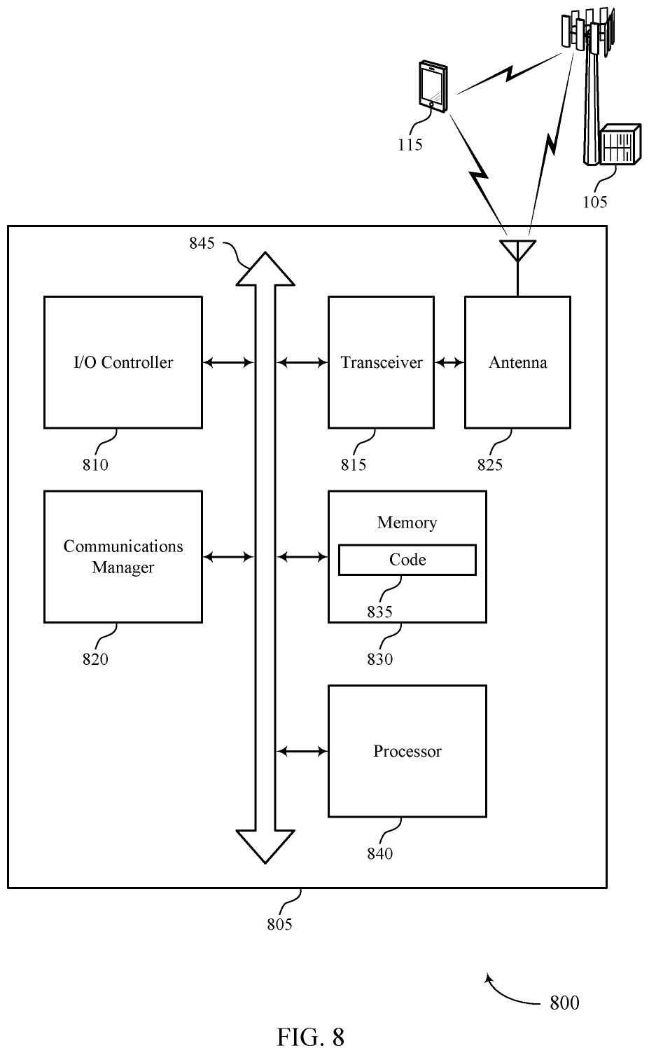

FIG. 8 shows a diagram of a system 800 including a device 805 that supports slot aggregation modification for wireless devices with mechanical displacement capability in accordance with one or more aspects of the present disclosure. The device 805 may be an example of or include components of a device 505, a device 605, or a device as described herein. The device 805 may include components for bi-directional voice and data communications including components for transmitting and receiving communications, such as a communications manager 820, an I/O controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include RAM and ROM. The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a BIOS which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting slot aggregation modification for wireless devices with mechanical displacement capability). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a control signal that indicates one or more parameters for slot aggregation for the device, the slot aggregation associated with repetition of a transmission across a set of multiple consecutive slots. The communications manager 820 is capable of, configured to, or operable to support a means for performing a mechanical displacement operation associated with a physical displacement of one or more antenna panels of the device. The communications manager 820 is capable of, configured to, or operable to support a means for transmitting, based on a latency capability of the device corresponding to the mechanical displacement operation, a slot aggregation modification signal that requests modification of the one or more parameters for the slot aggregation, the latency capability associated with a latency greater than a threshold latency.

By including or configuring the communications manager 820 in accordance with examples as described herein, the device 805 may support techniques for improved communication reliability, improved user experience related to reduced processing, reduced power consumption, more efficient utilization of communication resources, improved coordination between devices, improved utilization of processing capability, and the like.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of slot aggregation modification for wireless devices with mechanical displacement capability as described herein, or the at least one processor 840 and the at least one memory 830 may be otherwise configured to, individually or collectively, perform or support such operations.

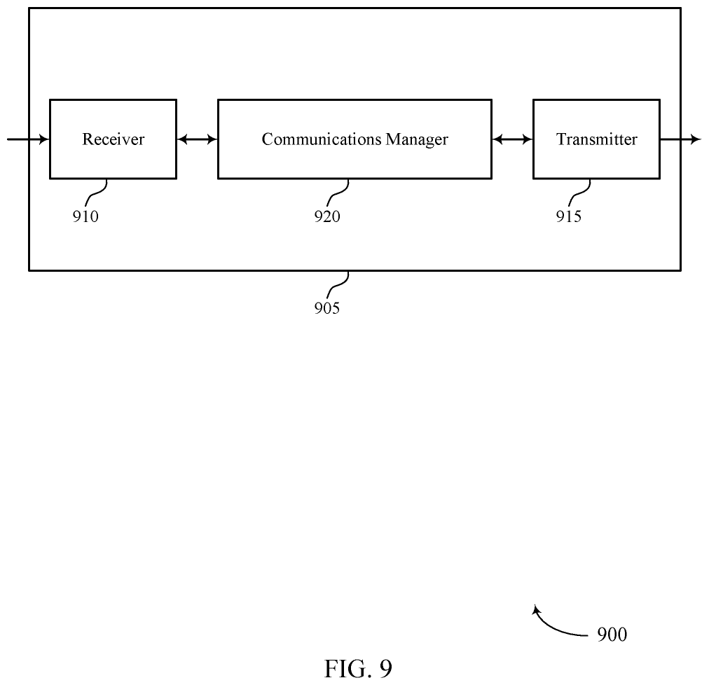

FIG. 9 shows a block diagram 900 of a device 905 that supports slot aggregation modification for wireless devices with mechanical displacement capability in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of slot aggregation modification for wireless devices with mechanical displacement capability as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting a control signal that indicates one or more parameters for slot aggregation for a device, the slot aggregation associated with repetition of a transmission across a set of multiple consecutive slots. The communications manager 920 is capable of, configured to, or operable to support a means for obtaining, from the device based on a latency capability of the device corresponding to a mechanical displacement operation of the device, a slot aggregation modification signal that requests modification of the one or more parameters for the slot aggregation, the latency capability associated with a latency greater than a threshold latency. The communications manager 920 is capable of, configured to, or operable to support a means for outputting, based on the slot aggregation modification signal, one or more modified parameters for the slot aggregation.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced power consumption, more efficient utilization of communication, and the like.

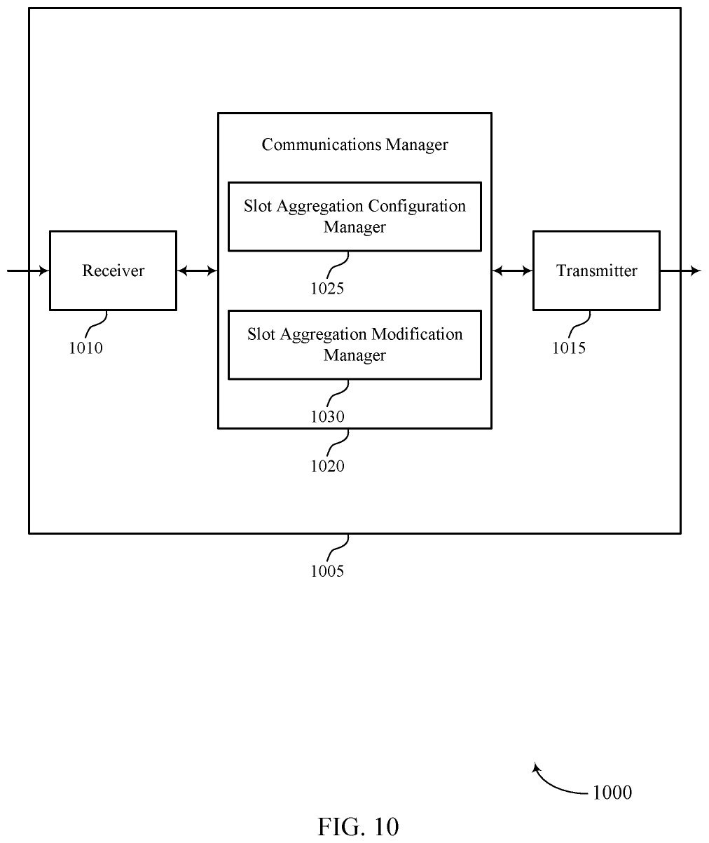

FIG. 10 shows a block diagram 1000 of a device 1005 that supports slot aggregation modification for wireless devices with mechanical displacement capability in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of slot aggregation modification for wireless devices with mechanical displacement capability as described herein. For example, the communications manager 1020 may include a slot aggregation configuration manager 1025 a slot aggregation modification manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The slot aggregation configuration manager 1025 is capable of, configured to, or operable to support a means for outputting a control signal that indicates one or more parameters for slot aggregation for a device, the slot aggregation associated with repetition of a transmission across a set of multiple consecutive slots. The slot aggregation modification manager 1030 is capable of, configured to, or operable to support a means for obtaining, from the device based on a latency capability of the device corresponding to a mechanical displacement operation of the device, a slot aggregation modification signal that requests modification of the one or more parameters for the slot aggregation, the latency capability associated with a latency greater than a threshold latency. The slot aggregation configuration manager 1025 is capable of, configured to, or operable to support a means for outputting, based on the slot aggregation modification signal, one or more modified parameters for the slot aggregation.

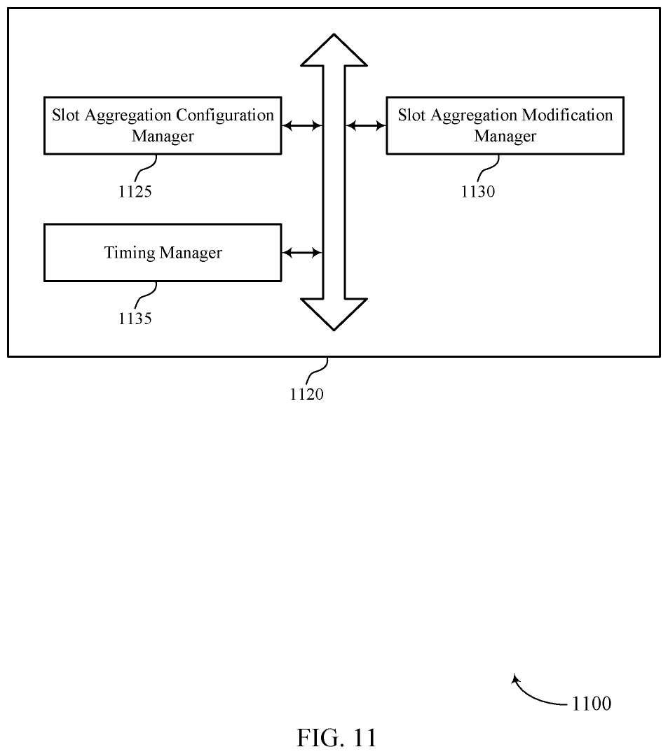

FIG. 11 shows a block diagram 1100 of a communications manager 1120 that supports slot aggregation modification for wireless devices with mechanical displacement capability in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of slot aggregation modification for wireless devices with mechanical displacement capability as described herein. For example, the communications manager 1120 may include a slot aggregation configuration manager 1125, a slot aggregation modification manager 1130, a timing manager 1135, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The slot aggregation configuration manager 1125 is capable of, configured to, or operable to support a means for outputting a control signal that indicates one or more parameters for slot aggregation for a device, the slot aggregation associated with repetition of a transmission across a set of multiple consecutive slots. The slot aggregation modification manager 1130 is capable of, configured to, or operable to support a means for obtaining, from the device based on a latency capability of the device corresponding to a mechanical displacement operation of the device, a slot aggregation modification signal that requests modification of the one or more parameters for the slot aggregation, the latency capability associated with a latency greater than a threshold latency. In some examples, the slot aggregation configuration manager 1125 is capable of, configured to, or operable to support a means for outputting, based on the slot aggregation modification signal, one or more modified parameters for the slot aggregation.

In some examples, the slot aggregation modification manager 1130 is capable of, configured to, or operable to support a means for obtaining, via the slot aggregation modification signal, a request to cancel the slot aggregation for at least a time period based on the mechanical displacement operation being performed by the device within the time period.

In some examples, the slot aggregation configuration manager 1125 is capable of, configured to, or operable to support a means for outputting, based on the request to cancel the slot aggregation, a second control signal that indicates a slot aggregation factor for the device, where the slot aggregation factor is associated with a pause in the slot aggregation.

In some examples, the timing manager 1135 is capable of, configured to, or operable to support a means for obtaining, at a first time via the slot aggregation modification signal, an indication of the time period associated with performance of the mechanical displacement operation, where the first time is at the same time as or before a beginning of the time period.

In some examples, the timing manager 1135 is capable of, configured to, or operable to support a means for obtaining a slot aggregation factor that indicates the time period.

In some examples, the slot aggregation modification manager 1130 is capable of, configured to, or operable to support a means for obtaining, via the slot aggregation modification signal, an indication of a change in one or more communication parameters associated with the device, the change in the one or more communication parameters based on the mechanical displacement operation of the device.

In some examples, the one or more communication parameters including a gain associated with the device.

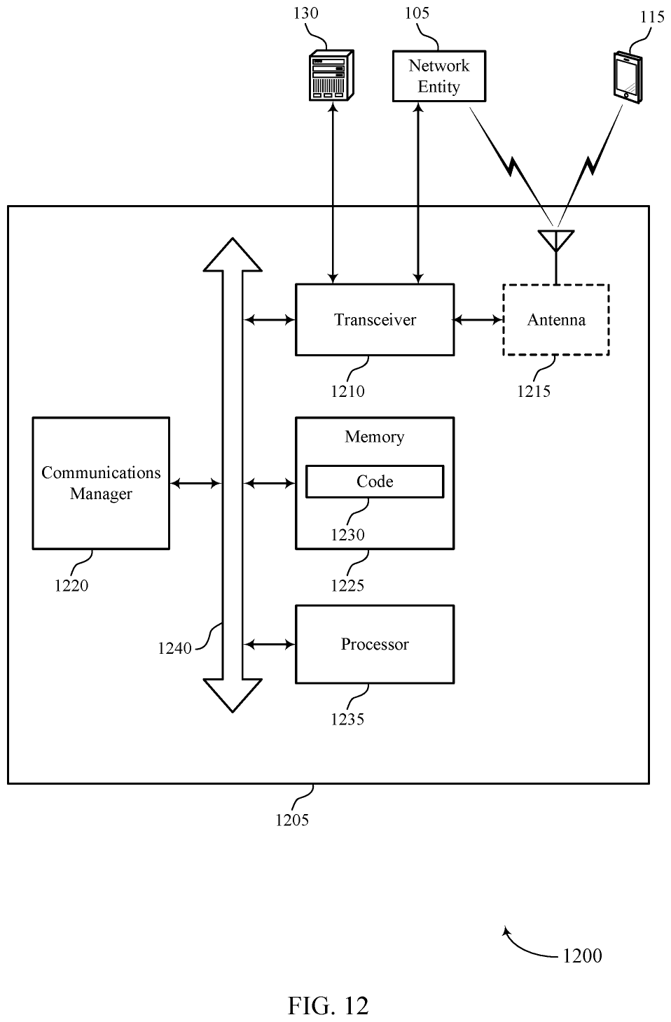

FIG. 12 shows a diagram of a system 1200 including a device 1205 that supports slot aggregation modification for wireless devices with mechanical displacement capability in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., a communication link 125, a backhaul communication link 120, a midhaul communication link 162, a fronthaul communication link 168).

The at least one memory 1225 may include RAM, ROM, or any combination thereof. The at least one memory 1225 may store computer-readable, computer-executable code 1230 including instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may contain, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting slot aggregation modification for wireless devices with mechanical displacement capability). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting a control signal that indicates one or more parameters for slot aggregation for a device, the slot aggregation associated with repetition of a transmission across a set of multiple consecutive slots. The communications manager 1220 is capable of, configured to, or operable to support a means for obtaining, from the device based on a latency capability of the device corresponding to a mechanical displacement operation of the device, a slot aggregation modification signal that requests modification of the one or more parameters for the slot aggregation, the latency capability associated with a latency greater than a threshold latency. The communications manager 1220 is capable of, configured to, or operable to support a means for outputting, based on the slot aggregation modification signal, one or more modified parameters for the slot aggregation.

By including or configuring the communications manager 1220 in accordance with examples as described herein, the device 1205 may support techniques for improved communication reliability, improved user experience related to reduced processing, reduced power consumption, more efficient utilization of communication resources, improved coordination between devices, improved utilization of processing capability, and the like.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of slot aggregation modification for wireless devices with mechanical displacement capability as described herein, or the at least one processor 1235 and the at least one memory 1225 may be otherwise configured to, individually or collectively, perform or support such operations.

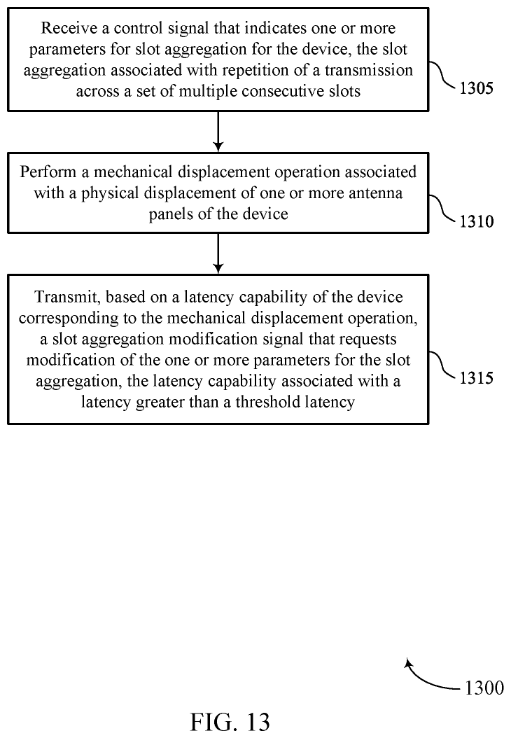

FIG. 13 shows a flowchart illustrating a method 1300 that supports slot aggregation modification for wireless devices with mechanical displacement capability in accordance with one or more aspects of the present disclosure. The operations of the method 1300 may be implemented by a device or its components as described herein. For example, the operations of the method 1300 may be performed by a device as described with reference to FIGS. 1 through 8. In some examples, a device may execute a set of instructions to control the functional elements of the device to perform the described functions. Additionally, or alternatively, the device may perform aspects of the described functions using special-purpose hardware.

At 1305, the method may include receiving a control signal that indicates one or more parameters for slot aggregation for the device, the slot aggregation associated with repetition of a transmission across a set of multiple consecutive slots. The operations of 1305 may be performed in accordance with examples as disclosed herein. In some examples, aspects of the operations of 1305 may be performed by a slot aggregation configuration component 725 as described with reference to FIG. 7.

At 1310, the method may include performing a mechanical displacement operation associated with a physical displacement of one or more antenna panels of the device. The operations of 1310 may be performed in accordance with examples as disclosed herein. In some examples, aspects of the operations of 1310 may be performed by a mechanical component 730 as described with reference to FIG. 7.

At 1315, the method may include transmitting, based on a latency capability of the device corresponding to the mechanical displacement operation, a slot aggregation modification signal that requests modification of the one or more parameters for the slot aggregation, the latency capability associated with a latency greater than a threshold latency. The operations of 1315 may be performed in accordance with examples as disclosed herein. In some examples, aspects of the operations of 1315 may be performed by a slot aggregation modification component 735 as described with reference to FIG. 7.

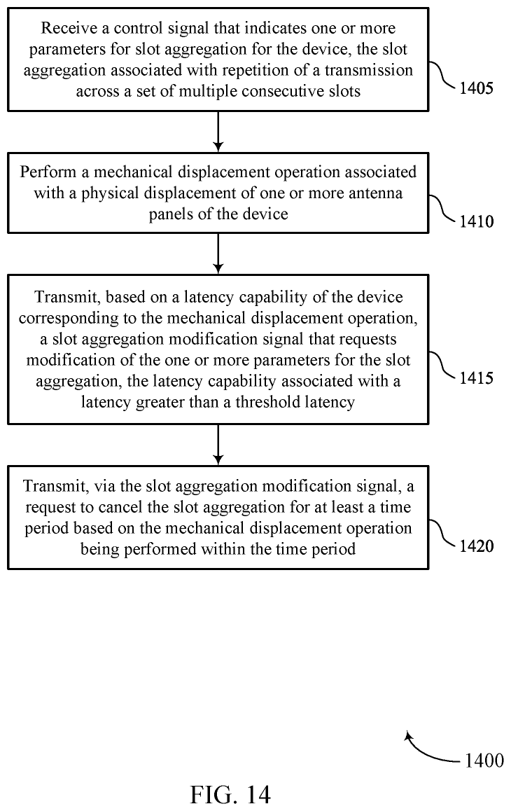

FIG. 14 shows a flowchart illustrating a method 1400 that supports slot aggregation modification for wireless devices with mechanical displacement capability in accordance with one or more aspects of the present disclosure. The operations of the method 1400 may be implemented by a device or its components as described herein. For example, the operations of the method 1400 may be performed by a device as described with reference to FIGS. 1 through 8. In some examples, a device may execute a set of instructions to control the functional elements of the device to perform the described functions. Additionally, or alternatively, the device may perform aspects of the described functions using special-purpose hardware.

At 1405, the method may include receiving a control signal that indicates one or more parameters for slot aggregation for the device, the slot aggregation associated with repetition of a transmission across a set of multiple consecutive slots. The operations of 1405 may be performed in accordance with examples as disclosed herein. In some examples, aspects of the operations of 1405 may be performed by a slot aggregation configuration component 725 as described with reference to FIG. 7.

At 1410, the method may include performing a mechanical displacement operation associated with a physical displacement of one or more antenna panels of the device. The operations of 1410 may be performed in accordance with examples as disclosed herein. In some examples, aspects of the operations of 1410 may be performed by a mechanical component 730 as described with reference to FIG. 7.

At 1415, the method may include transmitting, based on a latency capability of the device corresponding to the mechanical displacement operation, a slot aggregation modification signal that requests modification of the one or more parameters for the slot aggregation, the latency capability associated with a latency greater than a threshold latency. The operations of 1415 may be performed in accordance with examples as disclosed herein. In some examples, aspects of the operations of 1415 may be performed by a slot aggregation modification component 735 as described with reference to FIG. 7.

At 1420, the method may include transmitting, via the slot aggregation modification signal, a request to cancel the slot aggregation for at least a time period based on the mechanical displacement operation being performed within the time period. The operations of 1420 may be performed in accordance with examples as disclosed herein. In some examples, aspects of the operations of 1420 may be performed by a slot aggregation modification component 735 as described with reference to FIG. 7.

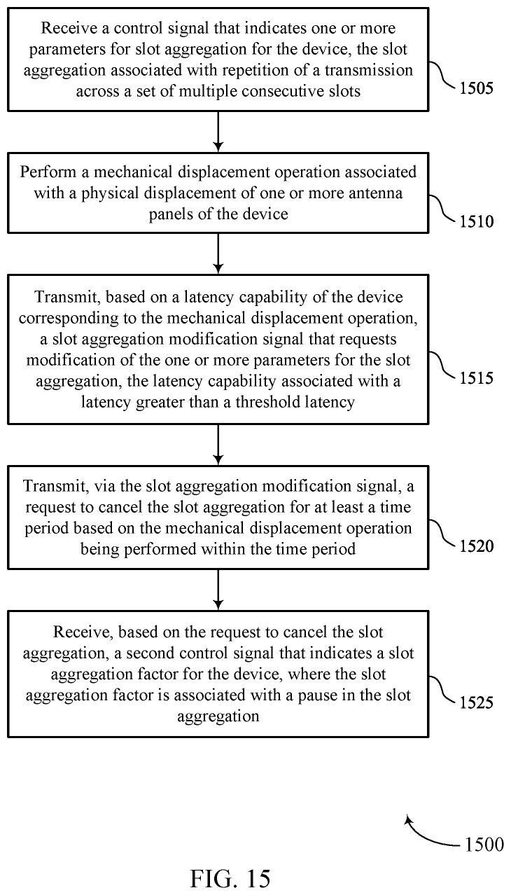

FIG. 15 shows a flowchart illustrating a method 1500 that supports slot aggregation modification for wireless devices with mechanical displacement capability in accordance with one or more aspects of the present disclosure. The operations of the method 1500 may be implemented by a device or its components as described herein. For example, the operations of the method 1500 may be performed by a device as described with reference to FIGS. 1 through 8. In some examples, a device may execute a set of instructions to control the functional elements of the device to perform the described functions. Additionally, or alternatively, the device may perform aspects of the described functions using special-purpose hardware.

At 1505, the method may include receiving a control signal that indicates one or more parameters for slot aggregation for the device, the slot aggregation associated with repetition of a transmission across a set of multiple consecutive slots. The operations of 1505 may be performed in accordance with examples as disclosed herein. In some examples, aspects of the operations of 1505 may be performed by a slot aggregation configuration component 725 as described with reference to FIG. 7.

At 1510, the method may include performing a mechanical displacement operation associated with a physical displacement of one or more antenna panels of the device. The operations of 1510 may be performed in accordance with examples as disclosed herein. In some examples, aspects of the operations of 1510 may be performed by a mechanical component 730 as described with reference to FIG. 7.

At 1515, the method may include transmitting, based on a latency capability of the device corresponding to the mechanical displacement operation, a slot aggregation modification signal that requests modification of the one or more parameters for the slot aggregation, the latency capability associated with a latency greater than a threshold latency. The operations of 1515 may be performed in accordance with examples as disclosed herein. In some examples, aspects of the operations of 1515 may be performed by a slot aggregation modification component 735 as described with reference to FIG. 7.

At 1520, the method may include transmitting, via the slot aggregation modification signal, a request to cancel the slot aggregation for at least a time period based on the mechanical displacement operation being performed within the time period. The operations of 1520 may be performed in accordance with examples as disclosed herein. In some examples, aspects of the operations of 1520 may be performed by a slot aggregation modification component 735 as described with reference to FIG. 7.

At 1525, the method may include receiving, based on the request to cancel the slot aggregation, a second control signal that indicates a slot aggregation factor for the device, where the slot aggregation factor is associated with a pause in the slot aggregation. The operations of 1525 may be performed in accordance with examples as disclosed herein. In some examples, aspects of the operations of 1525 may be performed by a slot aggregation configuration component 725 as described with reference to FIG. 7.

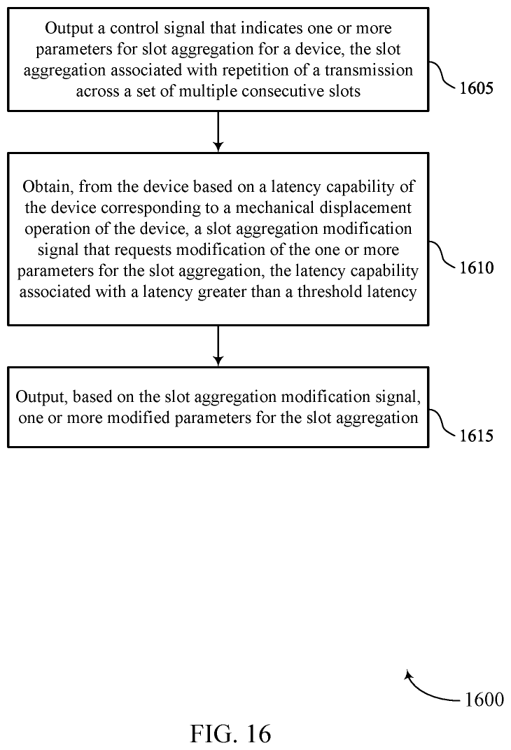

FIG. 16 shows a flowchart illustrating a method 1600 that supports slot aggregation modification for wireless devices with mechanical displacement capability in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include outputting a control signal that indicates one or more parameters for slot aggregation for a device, the slot aggregation associated with repetition of a transmission across a set of multiple consecutive slots. The operations of 1605 may be performed in accordance with examples as disclosed herein. In some examples, aspects of the operations of 1605 may be performed by a slot aggregation configuration manager 1125 as described with reference to FIG. 11.

At 1610, the method may include obtaining, from the device based on a latency capability of the device corresponding to a mechanical displacement operation of the device, a slot aggregation modification signal that requests modification of the one or more parameters for the slot aggregation, the latency capability associated with a latency greater than a threshold latency. The operations of 1610 may be performed in accordance with examples as disclosed herein. In some examples, aspects of the operations of 1610 may be performed by a slot aggregation modification manager 1130 as described with reference to FIG. 11.

At 1615, the method may include outputting, based on the slot aggregation modification signal, one or more modified parameters for the slot aggregation. The operations of 1615 may be performed in accordance with examples as disclosed herein. In some examples, aspects of the operations of 1615 may be performed by a slot aggregation configuration manager 1125 as described with reference to FIG. 11.

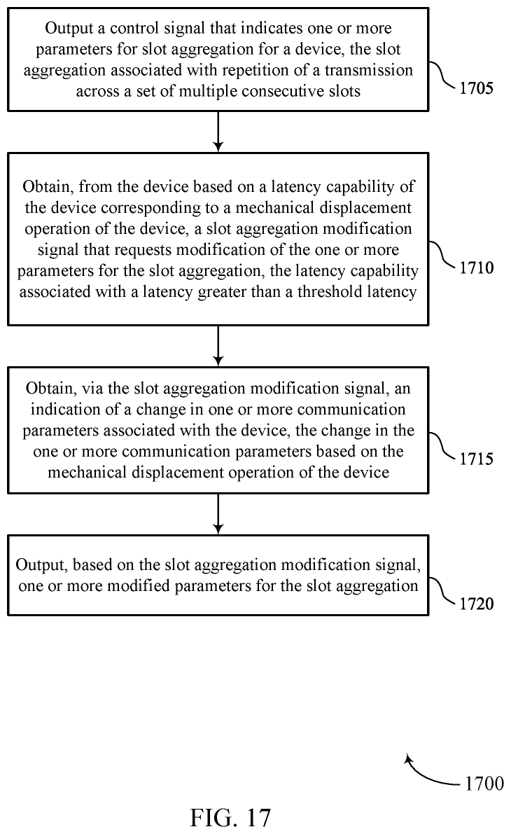

FIG. 17 shows a flowchart illustrating a method 1700 that supports slot aggregation modification for wireless devices with mechanical displacement capability in accordance with one or more aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include outputting a control signal that indicates one or more parameters for slot aggregation for a device, the slot aggregation associated with repetition of a transmission across a set of multiple consecutive slots. The operations of 1705 may be performed in accordance with examples as disclosed herein. In some examples, aspects of the operations of 1705 may be performed by a slot aggregation configuration manager 1125 as described with reference to FIG. 11.

At 1710, the method may include obtaining, from the device based on a latency capability of the device corresponding to a mechanical displacement operation of the device, a slot aggregation modification signal that requests modification of the one or more parameters for the slot aggregation, the latency capability associated with a latency greater than a threshold latency. The operations of 1710 may be performed in accordance with examples as disclosed herein. In some examples, aspects of the operations of 1710 may be performed by a slot aggregation modification manager 1130 as described with reference to FIG. 11.

At 1715, the method may include obtaining, via the slot aggregation modification signal, an indication of a change in one or more communication parameters associated with the device, the change in the one or more communication parameters based on the mechanical displacement operation of the device. The operations of 1715 may be performed in accordance with examples as disclosed herein. In some examples, aspects of the operations of 1715 may be performed by a slot aggregation modification manager 1130 as described with reference to FIG. 11.

At 1720, the method may include outputting, based on the slot aggregation modification signal, one or more modified parameters for the slot aggregation. The operations of 1720 may be performed in accordance with examples as disclosed herein. In some examples, aspects of the operations of 1720 may be performed by a slot aggregation configuration manager 1125 as described with reference to FIG. 11.

The following provides an overview of aspects of the present disclosure:

Aspect 1: An apparatus for wireless communication at a device, comprising: one or more memories; and one or more processors coupled with the one or more memories and configured to cause the device to: receive a control signal that indicates one or more parameters for slot aggregation for the device, the slot aggregation associated with repetition of a transmission across a plurality of consecutive slots; perform a mechanical displacement operation associated with a physical displacement of one or more antenna panels of the device; and transmit, based at least in part on a latency capability of the device corresponding to the mechanical displacement operation, a slot aggregation modification signal that requests modification of the one or more parameters for the slot aggregation, the latency capability associated with a latency greater than a threshold latency.

Aspect 2: The apparatus of aspect 1, wherein, to transmit the slot aggregation modification signal, the one or more processors are configured to cause the device to: transmit, via the slot aggregation modification signal, a request to cancel the slot aggregation for at least a time period based at least in part on the mechanical displacement operation being performed within the time period.

Aspect 3: The apparatus of aspect 2, wherein the one or more processors are configured to cause the device to: receive, based at least in part on the request to cancel the slot aggregation, a second control signal that indicates a slot aggregation factor for the device, wherein the slot aggregation factor is associated with a pause in the slot aggregation.

Aspect 4: The apparatus of any of aspects 1 through 3, wherein, to transmit the slot aggregation modification signal, the one or more processors are configured to cause the device to: transmit, at a first time via the slot aggregation modification signal, an indication of the time period associated with performance of the mechanical displacement operation, wherein the first time is at the same time as or before a beginning of the time period.

Aspect 5: The apparatus of aspect 4, wherein, to transmit the indication of the time period, the one or more processors are configured to cause the device to: transmit a slot aggregation factor that indicates the time period.

Aspect 6: The apparatus of any of aspects 1 through 5, wherein, to perform the mechanical displacement operation, the one or more processors are configured to cause the device to: rotate, displace, or reflect signals associated with the one or more antenna panels of the device.

Aspect 7: The apparatus of aspect 1, wherein, to transmit the slot aggregation modification signal, the one or more processors are configured to cause the device to: transmit, via the slot aggregation modification signal, an indication of a change in one or more communication parameters associated with the device, the change in the one or more communication parameters based at least in part on the mechanical displacement operation.

Aspect 8: The apparatus of aspect 7, wherein the one or more processors are configured to cause the device to: detect an error associated with the mechanical displacement operation at the device, the change in the one or more communication parameters based at least in part on the error.

Aspect 9: The apparatus of any of aspects 7 through 8, the one or more communication parameters comprising a gain associated with the device.

Aspect 10: The apparatus of any of aspects 1 through 9, the device comprising a plurality of antenna panels.

Aspect 11: An apparatus for wireless communication at a network entity, comprising: one or more memories; and one or more processors coupled with the one or more memories and configured to cause the network entity to: output a control signal that indicates one or more parameters for slot aggregation for a device, the slot aggregation associated with repetition of a transmission across a plurality of consecutive slots; obtain, from the device based at least in part on a latency capability of the device corresponding to a mechanical displacement operation of the device, a slot aggregation modification signal that requests modification of the one or more parameters for the slot aggregation, the latency capability associated with a latency greater than a threshold latency; and output, based at least in part on the slot aggregation modification signal, one or more modified parameters for the slot aggregation.

Aspect 12: The apparatus of aspect 11, wherein, to obtain the slot aggregation modification signal, the one or more processors are configured to cause the network entity to: obtain, via the slot aggregation modification signal, a request to cancel the slot aggregation for at least a time period based at least in part on the mechanical displacement operation being performed by the device within the time period.

Aspect 13: The apparatus of aspect 12, wherein the one or more processors are configured to cause the network entity to: output, based at least in part on the request to cancel the slot aggregation, a second control signal that indicates a slot aggregation factor for the device, wherein the slot aggregation factor is associated with a pause in the slot aggregation.

Aspect 14: The apparatus of any of aspects 12 through 13, wherein, to obtain the slot aggregation modification signal, the one or more processors are configured to cause the network entity to: obtain, at a first time via the slot aggregation modification signal, an indication of the time period associated with performance of the mechanical displacement operation, wherein the first time is at the same time as or before a beginning of the time period.

Aspect 15: The apparatus of aspect 14, wherein, to obtain the indication of the time period, the one or more processors are configured to cause the network entity to: obtain a slot aggregation factor that indicates the time period.

Aspect 16: The apparatus of aspects 11, wherein, to obtain the slot aggregation modification signal, the one or more processors are configured to cause the network entity to: obtain, via the slot aggregation modification signal, an indication of a change in one or more communication parameters associated with the device, the change in the one or more communication parameters based at least in part on the mechanical displacement operation of the device.

Aspect 17: The apparatus of aspect 16, the one or more communication parameters comprising a gain associated with the device.

Aspect 18: A method for wireless communications at a device, comprising: receiving a control signal that indicates one or more parameters for slot aggregation for the device, the slot aggregation associated with repetition of a transmission across a plurality of consecutive slots; performing a mechanical displacement operation associated with a physical displacement of one or more antenna panels of the device; and transmitting, based at least in part on a latency capability of the device corresponding to the mechanical displacement operation, a slot aggregation modification signal that requests modification of the one or more parameters for the slot aggregation, the latency capability associated with a latency greater than a threshold latency.

Aspect 19: The method of aspect 18, the transmitting the slot aggregation modification signal comprising: transmitting, via the slot aggregation modification signal, a request to cancel the slot aggregation for at least a time period based at least in part on the mechanical displacement operation being performed within the time period.

Aspect 20: The method of aspect 19, further comprising: receiving, based at least in part on the request to cancel the slot aggregation, a second control signal that indicates a slot aggregation factor for the device, wherein the slot aggregation factor is associated with a pause in the slot aggregation.

Aspect 21: The method of any of aspects 19 through 20, the transmitting the slot aggregation modification signal comprising: transmitting, at a first time via the slot aggregation modification signal, an indication of the time period associated with performance of the mechanical displacement operation, wherein the first time is at the same time as or before a beginning of the time period.

Aspect 22: The method of aspect 21, the transmitting the indication of the time period comprising: transmitting a slot aggregation factor that indicates the time period.

Aspect 23: The method of any of aspects 18 through 22, the performing the mechanical displacement operation comprising: rotating, displacing, or reflecting signals associated with the one or more antenna panels of the device.

Aspect 24: The method of aspects 18, the transmitting the slot aggregation modification signal comprising: transmitting, via the slot aggregation modification signal, an indication of a change in one or more communication parameters associated with the device, the change in the one or more communication parameters based at least in part on the mechanical displacement operation.

Aspect 25: The method of aspect 24, further comprising: detecting an error associated with the mechanical displacement operation at the device, the change in the one or more communication parameters based at least in part on the error.

Aspect 26: The method of any of aspects 24 through 25, wherein the one or more communication parameters comprising a gain associated with the device.

Aspect 27: The method of any of aspects 18 through 26, wherein the device comprising a plurality of antenna panels.

Aspect 28: A method for wireless communications at a network entity, comprising: outputting a control signal that indicates one or more parameters for slot aggregation for a device, the slot aggregation associated with repetition of a transmission across a plurality of consecutive slots; obtaining, from the device based at least in part on a latency capability of the device corresponding to a mechanical displacement operation of the device, a slot aggregation modification signal that requests modification of the one or more parameters for the slot aggregation, the latency capability associated with a latency greater than a threshold latency; and outputting, based at least in part on the slot aggregation modification signal, one or more modified parameters for the slot aggregation.

Aspect 29: The method of aspect 28, the obtaining the slot aggregation modification signal comprising: obtaining, via the slot aggregation modification signal, a request to cancel the slot aggregation for at least a time period based at least in part on the mechanical displacement operation being performed by the device within the time period.

Aspect 30: The method of aspect 29, further comprising: outputting, based at least in part on the request to cancel the slot aggregation, a second control signal that indicates a slot aggregation factor for the device, wherein the slot aggregation factor is associated with a pause in the slot aggregation.

Aspect 31: The method of any of aspects 29 through 30, the obtaining the slot aggregation modification signal comprising: obtaining, at a first time via the slot aggregation modification signal, an indication of the time period associated with performance of the mechanical displacement operation, wherein the first time is at the same time as or before a beginning of the time period.

Aspect 32: The method of aspect 31, the obtaining the indication of the time period comprising: obtaining a slot aggregation factor that indicates the time period.

Aspect 33: The method of aspects 28, the obtaining the slot aggregation modification signal comprising: obtaining, via the slot aggregation modification signal, an indication of a change in one or more communication parameters associated with the device, the change in the one or more communication parameters based at least in part on the mechanical displacement operation of the device.

Aspect 34: The method of aspect 33, wherein the one or more communication parameters comprising a gain associated with the device.

Aspect 35: A device for wireless communications, comprising at least one means for performing a method of any of aspects 18 through 27.

Aspect 36: A non-transitory computer-readable medium storing code for wireless communications, the code comprising instructions executable by one or more processors to perform a method of any of aspects 18 through 27.

Aspect 37: A network entity for wireless communications, comprising at least one means for performing a method of any of aspects 28 through 34.

Aspect 38: A non-transitory computer-readable medium storing code for wireless communications, the code comprising instructions executable by one or more processors to perform a method of any of aspects 28 through 34.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a device, comprising:
one or more memories; and
one or more processors coupled with the one or more memories and configured to cause the device to:
receive a control signal that indicates one or more parameters for slot aggregation for the device, the slot aggregation associated with repetition of a transmission across a plurality of consecutive slots;
perform a mechanical displacement operation associated with a physical displacement of one or more antenna panels of the device; and
transmit, based at least in part on a latency capability of the device corresponding to the mechanical displacement operation, a slot aggregation modification signal that requests modification of the one or more parameters for the slot aggregation, the latency capability associated with a latency greater than a threshold latency.

2. The apparatus of claim 1, wherein, to transmit the slot aggregation modification signal, the one or more processors are configured to cause the device to:
transmit, via the slot aggregation modification signal, a request to cancel the slot aggregation for at least a time period based at least in part on the mechanical displacement operation being performed within the time period.

3. The apparatus of claim 2, wherein the one or more processors are configured to cause the device to:
receive, based at least in part on the request to cancel the slot aggregation, a second control signal that indicates a slot aggregation factor for the device, wherein the slot aggregation factor is associated with a pause in the slot aggregation.

4. The apparatus of claim 2, wherein, to transmit the slot aggregation modification signal, the one or more processors are configured to cause the device to:
transmit, at a first time via the slot aggregation modification signal, an indication of the time period associated with performance of the mechanical displacement operation, wherein the first time is at the same time as or before a beginning of the time period.

5. The apparatus of claim 4, wherein, to transmit the indication of the time period, the one or more processors are configured to cause the device to:
transmit a slot aggregation factor that indicates the time period.

6. The apparatus of claim 1, wherein, to perform the mechanical displacement operation, the one or more processors are configured to cause the device to:
rotate, displace, or reflect signals associated with the one or more antenna panels of the device.

7. The apparatus of claim 1, wherein, to transmit the slot aggregation modification signal, the one or more processors are configured to cause the device to:
transmit, via the slot aggregation modification signal, an indication of a change in one or more communication parameters associated with the device, the change in the one or more communication parameters based at least in part on the mechanical displacement operation.

8. The apparatus of claim 7, wherein the one or more processors are configured to cause the device to:
detect an error associated with the mechanical displacement operation at the device, the change in the one or more communication parameters based at least in part on the error.

9. The apparatus of claim 7, the one or more communication parameters comprising a gain associated with the device.

10. The apparatus of claim 1, the device comprising a plurality of antenna panels.

11. An apparatus for wireless communication at a network entity, comprising:
one or more memories; and
one or more processors coupled with the one or more memories and configured to cause the network entity to:
output a control signal that indicates one or more parameters for slot aggregation for a device, the slot aggregation associated with repetition of a transmission across a plurality of consecutive slots;
obtain, from the device based at least in part on a latency capability of the device corresponding to a mechanical displacement operation of the device, a slot aggregation modification signal that requests modification of the one or more parameters for the slot aggregation, the latency capability associated with a latency greater than a threshold latency; and
output, based at least in part on the slot aggregation modification signal, one or more modified parameters for the slot aggregation.

12. The apparatus of claim 11, wherein, to obtain the slot aggregation modification signal, the one or more processors are configured to cause the network entity to:
obtain, via the slot aggregation modification signal, a request to cancel the slot aggregation for at least a time period based at least in part on the mechanical displacement operation being performed by the device within the time period.

13. The apparatus of claim 12, wherein the one or more processors are configured to cause the network entity to:
output, based at least in part on the request to cancel the slot aggregation, a second control signal that indicates a slot aggregation factor for the device, wherein the slot aggregation factor is associated with a pause in the slot aggregation.

14. The apparatus of claim 12, wherein, to obtain the slot aggregation modification signal, the one or more processors are configured to cause the network entity to:
obtain, at a first time via the slot aggregation modification signal, an indication of the time period associated with performance of the mechanical displacement operation, wherein the first time is at the same time as or before a beginning of the time period.

15. The apparatus of claim 14, wherein, to obtain the indication of the time period, the one or more processors are configured to cause the network entity to:
obtain a slot aggregation factor that indicates the time period.

16. The apparatus of claim 11, wherein, to obtain the slot aggregation modification signal, the one or more processors are configured to cause the network entity to:
obtain, via the slot aggregation modification signal, an indication of a change in one or more communication parameters associated with the device, the change in the one or more communication parameters based at least in part on the mechanical displacement operation of the device.

17. The apparatus of claim 16, the one or more communication parameters comprising a gain associated with the device.

18. A method for wireless communications at a device, comprising:
receiving a control signal that indicates one or more parameters for slot aggregation for the device, the slot aggregation associated with repetition of a transmission across a plurality of consecutive slots;
performing a mechanical displacement operation associated with a physical displacement of one or more antenna panels of the device; and
transmitting, based at least in part on a latency capability of the device corresponding to the mechanical displacement operation, a slot aggregation modification signal that requests modification of the one or more parameters for the slot aggregation, the latency capability associated with a latency greater than a threshold latency.

19. The method of claim 18, the transmitting the slot aggregation modification signal comprising:
transmitting, via the slot aggregation modification signal, a request to cancel the slot aggregation for at least a time period based at least in part on the mechanical displacement operation being performed within the time period.

20. The method of claim 18, the performing the mechanical displacement operation comprising:
rotating, displacing, or reflecting signals associated with the one or more antenna panels of the device.
